(19) United States
(12) Patent Application Publication
(10) Pub. No.: US 2005/0103231 A1
(43) Pub. Date: May 19, 2005

(54) Granules based on pyrogenically prepared silicon dioxide, a process for their preparation and their use

(76) Inventors: Andreas Geisselmann, Frankfurt (DE); Juergen Meyer, Stockstadt (DE); Hermanus Gerhardus Jozef Lansink-Rotgerink, Moembris-Mensengesaess (DE); Natalia Hinrichs, Alzenau (DE)

Correspondence Address: VENABLE, BAETJER, HOWARD AND CIVILETTI, LLP, P.O. BOX 34385, WASHINGTON, DC, 20043-9998, US

(21) Appl. No.: 10/499,704

(22) PCT Filed: Sep. 27, 2002
(86) PCT No.: PCT/EP02/10857

(30) Foreign Application Priority Data
Dec. 21, 2001 (DE) 101 63 179.0

(51) Int. Cl. C01B 33/12; C04B 14/04

(52) U.S. Cl. 106/482; 106/491; 423/335

(57) ABSTRACT

Granules based on pyrogenically prepared silicon dioxide with the following physico-chemical characteristic data:

| | |
|---|---|
| Average particle diameter: | 10 to 120 μm |
| BET surface area: | 40 to 400 m²/g |
| Pore volume: | 0.5 to 2.5 ml/g |
| Pore distribution: | content of pores of pore |
| | diameter <5 nm in the total |
| | pore volume of less than 5%, |
| | remainder meso- and macropores |
| Tamped density: | 220 to 1,000 g/l |
| Numerical content of particles in the | <35% |
| particle size range above the D10 | |
| value of the particle size distribution | |
| weighted according to volume which | |
| have tucks or closed off inner hollow | |
| spaces: | |

They are prepared by a procedure in which silicon dioxide is dispersed in a liquid, preferably water, together with one or more auxiliaries, the dispersion is spray dried and the granules are optionally heat-treated and/or silanized. The granules are employed as a catalyst support.

The invention relates to granules based on pyrogenically prepared silicon dioxide, the process for their preparation and their use as a catalyst support.

It is known to prepare pyrogenic silicas or silicon dioxides from SiCl₄ by means of high temperature or flame hydrolysis (Ullmanns Enzyklopädie der technischen Chemie [Ullmanns Encyclopaedia of Industrial Chemistry], 4th edition, volume 21, page 464 (1982)).

Pyrogenic silicon dioxides are distinguished by an extreme fine division, a high specific surface area (BET), a very high purity, a spherical particle shape and the absence of pores. On the basis of these properties, pyrogenically prepared silicon dioxides are finding increasing interest as supports for catalysts (Dr. Koth et al., Chem. Ing. Techn. 52, 628 (1980)). For this use, the pyrogenically prepared silicon dioxide is shaped by a mechanical route by means of, for example, tablet-making machines.

It is also known to shape pyrogenically prepared silicon dioxide to spray granules by means of spray drying. U.S. Pat. No. 5,776,240 describes granules based on pyrogenic silicon dioxide which are obtainable by spray drying an aqueous suspension of pyrogenic silicon dioxide. Granules which are prepared in such a manner have the disadvantage that they have tucks on the surface (amphore formation), inner hollow spaces and deformations. Such effects are well-known in spray drying (K. Masters, Spray Drying, 2^{nd} ed., 1976, John Wiley & Sons, New York, p. 329). These morphological defects have an adverse effect in the use as a catalyst support. In olefin polymerization, for example, the form of the catalyst support is copied by the polymer grain due to the replica effect. This likewise results in hollow spaces and deformations in the polymer, which lower the bulk density (and therefore the capacity of the polymerization plant) or can have the effect of inclusion of monomers, which has an adverse effect in further processing. When used as a support for other fluidized bed catalysts, these defects lead to increased abrasion and therefore increased catalyst consumption.

There was therefore the object of developing improved spray granules of pyrogenically prepared silicon dioxide which can be employed as a catalyst support for olefin polymerization or other catalytic fluidized bed processes. These should be distinguished by a lower content of particles with tucks and hollow spaces compared with the prior art.

The invention provides granules based on pyrogenically prepared silicon dioxide with the following physico-chemical characteristic data:

| | |
|---|---|
| Average particle diameter: | 10 to 120 μm |
| BET surface area: | 40 to 400 m²/g |
| Pore volume: | 0.5 to 2.5 ml/g |
| Pore distribution: | content of pores of pore |
| | diameter <5 nm in the total |
| | pore volume of less than 5%, |
| | remainder meso- and macropores |
| Tamped density: | 220 to 1,000 g/l |
| Numerical content of particles in the | <35% |
| particle size range above the D10 | |
| value of the particle size distribution | |
| weighted according to volume which | |
| have tucks or closed off inner hollow | |
| spaces: | |

The granules according to the invention can be prepared by a procedure in which silicon dioxide prepared from a volatile silicon compound by means of flame hydrolysis is dispersed in a liquid, preferably water, with one or more organic or inorganic auxiliary substances, the dispersion is spray dried and the granules obtained are optionally heat-treated at a temperature of 150 to 1,100° C. and/or silanized.

Halogenosilanes, alkoxysilanes, silazanes and/or siloxanes can be employed for the silanization.

The following substances can be employed in particular as halogenosilanes:
Halogeno-organosilanes of the type X₃Si(CₙH₂ₙ₊₁)
   X=Cl, Br
   n=1-20
Halogeno-organosilanes of the type X₂(R′)Si(CₙH₂ₙ₊₁)
   X=Cl, Br
   R′=alkyl
   n=1-20
Halogeno-organosilanes of the type X(R′)₂Si(CₙH₂ₙ₊₁)
   X=Cl, Br
   R′=alkyl
   n=1-20
Halogeno-organosilanes of the type X₃Si(CH₂)ₘ—R′
X=Cl, Br
m=0,1-20
R′=alkyl, aryl (e.g. —C₆H₅)
   —C₄F₉, —OCF₂—CHF—CF₃, —C₆F₁₃, —O—CF₂—CHF₂
   —NH₂, —N₃, —SCN, —CH═CH₂,
   —OOC(CH₃)C═CH₂
   —OCH₂—CH(O)CH₂
   —NH—CO—N—CO—(CH₂)₅
   —NH—COO—CH₃, —NH—COO—CH₂—CH₃, —NH—(CH₂)₃Si(OR)₃
   —Sₓ—(CH₂)₃Si(OR)₃, wherein R is a lower alkyl and x is 0 or 1
Halogeno-organosilanes of the type (R)X₂Si(CH₂)ₘ—R′
X=Cl, Br
R=alkyl
m=0,1-20
R′=alkyl, aryl (e.g. —C₆H₅)
   —C₄F₉, —OCF₂—CHF—CF₃, —C₆F₁₃, —O—CF₂—CHF₂
   —NH₂, —N₃, —SCN, —CH═CH₂,
   —OOC(CH₃)C═CH₂
   —OCH₂—CH(O)CH₂
   —NH—CO—N—CO—(CH₂)₅
   —NH—COO—CH₃, —NH—COO—CH₂—CH₃, —NH—(CH₂)₃Si(OR)₃
   —Sₓ—(CH₂)₃Si(OR)₃, wherein R is a lower alkyl and x is 0 or 1
Halogeno-organosilanes of the type (R)₂X Si(CH₂)ₘ—R′
X=Cl, Br
R=alkyl
m=0,1-20
R′=alkyl, aryl (e.g. —C₆H₅)
   —C₄F₉, —OCF₂—CHF—CF₃, —C₆F₁₃, —O—CF₂—CHF₂
   —NH₂, —N₃, —SCN, —CH═CH₂,
   —OOC(CH₃)C═CH₂
   —OCH₂—CH(O)CH₂
   —NH—CO—N—CO—(CH₂)₅
   —NH—COO—CH₃, —NH—COO—CH₂—CH₃, —NH—(CH₂)₃Si(OR)₃
   —Sₓ—(CH₂)_{3,} Si(OR)₃, wherein R is a lower alkyl and x is 0 or 1

The following substances can be employed in particular as alkoxysilanes:
Organosilanes of the type (RO)₃Si(CₙH₂ₙ₊₁)
   R=alkyl
   n=1-20
Organosilanes of the type R′ₓ(RO)_{y}Si(CₙH₂ₙ₊₁)
   R=alkyl
   R′=alkyl
   n=1-20
   x+y=3
   x=1,2
   y=1,2
Organosilanes of the type (RO)₃Si(CH₂)ₘ—R′
R=alkyl
m=0,1-20
R′=alkyl, aryl (e.g. —C₆H₅)
   —C₄F₉, —OCF₂—CHF—CF₃, —C₆F₁₃, —O—CF₂—CHF₂
   —NH₂, —N₃, —SCN, —CH═CH₂,
   —OOC(CH₃)C═CH₂
   —OCH₂—CH(O)CH₂
   —NH—CO—N—CO—(CH₂)₅
   —NH—COO—CH₃, —NH—COO—CH₂—CH₃, —NH—(CH₂)₃Si(OR)₃
   —Sₓ—(CH₂)₃Si(OR)₃, wherein R is a lower alkyl and x is 0 or 1
Organosilanes of the type (R′)ₓ(RO)_{y}Si(CH₂)ₘ—R′, where m is 0 or 1-20
R′=alkyl
   x+y=2
   x=1,2
   y=1,2
R′=alkyl, aryl (e.g. —C₆H₅)
   —C₄F₉, —OCF₂—CHF—CF₃, —C₆F₁₃, —O—CF₂—CHF₂
   —NH₂, —N₃, —SCN, —CH═CH₂,
   —OOC(CH₃)C═CH₂
   —OCH₂—CH(O)CH₂
   —NH—CO—N—CO— (CH₂)₅
   —NH—COO—CH₃, —NH—COO—CH₂—CH₃, —NH—(CH₂)₃Si(OR)₃
   —Sₓ—(CH₂)₃Si(OR)₃ₗ

The silane Si 108 [(CH₃O)₃—S₁-C₈H₁₇] trimethoxyoctylsilane can preferably be employed as the silanizing agent.

The following substances can be employed in particular as silazanes:

Silazanes of the type 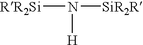
R=alkyl
R′=alkyl, vinyl
   and, for example, hexamethyldisilazane.

The following substances can be employed in particular as siloxanes:

Cyclic polysiloxanes of the type D 3, D 4, D 5 e.g. octamethylcyclotetrasiloxane=D 4

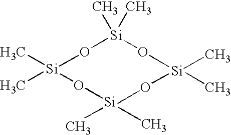

Polysiloxanes or silicone oils of the type 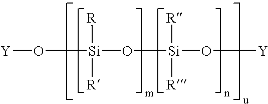
m=0, 1, 2, 3, . . . ∞
n=0, 1, 2, 3, . . . ∞
u=0, 1, 2, 3, . . . ∞
Y═CH₃, H, CₙH₂ₙ₊₁ n=1-20
Y═Si(CH₃)₃, Si(CH₃)₂H
Si (CH₃)₂OH, Si (CH₃) 2 (OCH₃)
Si (CH₃) 2 (CₙH₂ₙ₊₁) n=1-20
R=alkyl, aryl, (CH₂)ₙ—NH₂, H
R′=alkyl, aryl, (CH₂)ₙ—NH₂, H
R′=alkyl, aryl, (CH₂)ₙ—NH₂, H
R″=alkyl, aryl, (CH₂)ₙ—NH₂, H

The pore structure of the granules according to the invention has predominantly meso- and macropores. The content of pores smaller than 5 nm is not more than 5%, based on the total pore volume.

The granules can comprise as secondary constituents the auxiliary substances, residues of the auxiliary substances which have remained after the heat treatment and/or silane components. The carbon content of the granules according to the invention can be 0 to 15 wt. %.

The particle size distribution of the granules according to the invention can be of a form such that they have a volume content of at least 80% of particles larger than 5 μm and at least 80% of particles smaller than 120 μm.

The invention also provides a process for the preparation of granules based on pyrogenically prepared silicon dioxide, which is characterized in that pyrogenically prepared silicon dioxide, preferably silicon dioxide prepared from silicon tetrachloride by means of flame hydrolysis, is dispersed in a liquid with an organic or inorganic auxiliary substance, it being possible for the components of the dispersion to be added in any desired sequence, the dispersion is spray dried, the granules obtained are optionally heat-treated at a temperature of 150 to 1,100° C., the granules are optionally silanized and the granules are optionally subjected to a sifting or sieving, it being possible for the last three process steps mentioned to be carried out in any desired sequence.

The dispersion can have a concentration of silicon dioxide of 5 to 40 wt. %. The dispersing can be carried out continuously or discontinuously.

Water, ethanol, propanol, isopropanol, butanol, isobutanol, ethyl acetate or a mixture of these substances can be employed e.g. as the dispersing medium. Water is preferably employed as the dispersing medium.

Suitable auxiliary substances for the spray drying are, inter alia, organic auxiliary substances, such as polymers, e.g. cellulose derivatives, polyethylene glycol, waxes, polyolefins, polyacrylates or polyvinyl alcohols, or organic acids, e.g. lactic or citric acid, or inorganic auxiliary substances, such as water-glass, silica sols, aluminium oxide sols or sols of other oxides or tetraethyl orthosilicate. These auxiliary substances can be employed individually or in combination and have the effect of a more uniform shape of the spray particle and a reduced number of particles which have tucks or closed off inner hollow spaces.

In addition, further auxiliary substances which have the effect of lowering the viscosity, and therefore allow a higher degree of filling of the suspension, can optionally be added. Substances which are suitable for this are, for example, acids, such as formic acid, acetic acid, oxalic acid, hydrochloric acid or nitric acid, bases, such as ammonia, amines or alkali metal, alkylammonium or alkaline earth metal hydroxides, or other substances which have the effect of modifying the surface charge on the dispersed particles.

The auxiliary substances are preferably employed in a low dosage of 0.01 to 10 wt. %, based on the solids content of the dispersion, in order to minimize contamination.

The spray drying can preferably be carried out at an intake temperature of the drying gas of 180 to 700° C. and an exit temperature of 50 to 250° C. Disc atomizers or nozzle atomizers can be employed here. Any desired gases can be employed as the drying medium, preferably air or nitrogen.

The optional heat treatment of the granules can be carried out either in a static bed, such as, for example, in chamber ovens, or in an agitated bed, such as, for example, rotary tubular ovens or fluidized bed dryers or calciners.

The optional silanization can be carried out with the same halogenosilanes, alkoxysilanes, silazanes and/or siloxanes as described above, it being possible for the silanizing agent optionally to be dissolved in an organic solvent, such as, for example, ethanol.

The silane Si 108 [(CH₃O)₃—Si—C₈H₁₇] trimethoxyoctylsilane can preferably be employed as the silanizing agent.

The silanization can be carried out by a procedure in which the granules are sprayed with the silanizing agent at room temperature and the mixture is then heat-treated at a temperature of 105 to 400° C. over a period of 1 to 6 h.

An alternative method of the silanization of the granules can be carried out by a procedure in which the granules are treated with the silanizing agent in vapour form and the mixture is then heat-treated at a temperature of 50 to 800° C. over a period of 0.5 to 6 h.

The heat treatment can optionally be carried out under an inert gas, such as, for example, nitrogen.

The silanization can be carried out continuously or batchwise in heatable mixers and dryers with spray devices. Suitable devices can be, for example: plough share mixers or plate, fluidized bed or flow-bed dryers.

A wind sifter is preferably employed in the optional sifting, in order preferably to separate off fine particles. Alternatively or in addition, sieving can be employed to separate off coarse particles. The sifting can be carried out at any desired point of the process after the spray drying. Particle fractions which have been separated off can optionally be recycled by admixing them to the starting suspension.

By varying the starting substances, the conditions during spraying, the heat treatment and the silanization, the physico-chemical parameters of the granules, such as the specific surface area, the particle size distribution, the pore volume, the tamped density and the silanol group concentration, pore distribution and pH, can be modified within the stated limits.

The granules according to the invention can be employed as a support for catalysts, in particular as a support for catalysts for olefin polymerization, the preparation of phthalic anhydride, the preparation of vinyl acetate, the preparation of aniline or the Fischer-Tropsch synthesis.

They advantageously have a high purity, a high heat stability, a content of micropores of <5 nm in the total pore volume of less than 5% and a numerical content of particles with tucks or inner hollow spaces in the particle size range above the D10 value of the particle size distribution weighted according to volume of less than 35%.

The invention also provides the use of the granules as a catalyst support.

### EXAMPLES

Silicon dioxides with the following physico-chemical characteristic data are employed as pyrogenically prepared silicon dioxides:

TABLE 1

| | AEROSIL | AEROSIL | AEROSIL | AEROSIL | AEROSIL | AEROSIL | AEROSIL |
|---|---|---|---|---|---|---|---|
| | 90 | 130 | 150 | 200 | 300 | 380 | OX50 |
| CAS reg. number | 112945-52-5 (former no.: 7631-86-9 | | | | | | |
| Behaviour towards | hydrophilic | | | | | | |
| water | | | | | | | |
| Appearance | loose white powder | | | | | | |
| BET surface area¹⁾ | 90 ± 15 | 130 ± 25 | 150 ± 15 | 200 ± 25 | 300 ± 30 | 380 ± 30 | 50 ± 15 |
| m²/g | | | | | | | |
| Average primary | 20 | 16 | 14 | 12 | 7 | 7 | 40 |
| particle size nm | | | | | | | |
| Tamped density²⁾ | approx. | approx. | approx. | approx. | approx. | approx. | approx. |
| normal goods g/l | 80 | 50 | 50 | 50 | 50 | 50 | 130 |
| compacted goods g/l | — | approx. | approx. | approx. | approx. | approx. | — |
| (added “V”) | | 120 | 120 | 120 | 120 | 120 | |
| Loss on drying³⁾ | <1.0 | <1.5 | <0.5⁹⁾ | <1.5 | <1.5 | <1.5 | <1.5 |
| (2 h at 105° C.) % | | | | | | | |
| on leaving supply | | | | | | | |
| works | | | | | | | |
| Ignition loss⁴⁾⁷⁾ | <1 | <1 | <1 | <1 | <2 | <2.5 | <1 |
| (2 h at 1,000° C.) % | | | | | | | |
| pH⁵⁾ (in 4% aqueous | 3.6-4.5 | 3.6-4.3 | 3.6-4.3 | 3.6-4.3 | 3.6-4.3 | 3.6-4.3 | 3.6-4.3 |
| dispersion) | | | | | | | |
| SiO₂⁸⁾ % | >99.8 | >99.8 | >99.8 | >99.8 | >99.8 | >99.8 | >99.8 |
| Al₂O₃⁸⁾ % | <0.05 | <0.05 | <0.05 | <0.05 | <0.05 | <0.05 | <0.08 |
| Fe₂O₃⁸⁾ % | <0.003 | <0.003 | <0.003 | <0.003 | <0.003 | <0.003 | <0.01 |
| TiO₂⁸⁾ % | <0.03 | <0.03 | <0.03 | <0.03 | <0.03 | <0.03 | <0.03 |
| HCl⁸⁾¹¹⁾ % | <0.025 | <0.025 | <0.025 | <0.025 | <0.025 | <0.025 | <0.025 |
| Sieve residue⁶⁾ | <0.05 | <0.05 | <0.05 | <0.05 | <0.05 | <0.05 | 0.2 |
| (acc. to Mocker, 45 μm) % | | | | | | | |

¹⁾in accordance with DIN 66131
²⁾in accordance with DIN ISO 787/XI, JIS K 5101/18 (not sieved)
³⁾in accordance with DIN ISO 787/II, ASTM D 280, JIS K 5101/21
⁴⁾in accordance with DIN 55921, ASTM D 1208, JIS K 5101/23
⁵⁾in accordance with DIN ISO 787/IX, ASTM D 1208, JIS K 5101/24
⁶⁾in accordance with DIN ISO 787/XVIII, JIS K 5101/20
⁷⁾based on the substance dried for 2 hours at 105° C.
⁸⁾based on the substance ignited for 2 hours at 1.000° C.
⁹⁾special packaging protecting against moisture
¹⁰⁾in water:ethanol 1:1
¹¹⁾HCl content in constituent of the ignition loss

To prepare the silicon dioxides, a volatile silicon compound is injected into an oxyhydrogen gas flame of hydrogen and air. Silicon tetrachloride is used in most cases. This substance hydrolyses to silicon dioxide and hydrochloric acid under the influence of the water formed during the oxyhydrogen gas reaction. After leaving the flame the silicon dioxide enters into a so-called coagulation zone, in which the Aerosil primary particles and primary aggregates agglomerate. The product present as a type of aerosol in this stage is separated from the gaseous concomitant substances in cyclones and then after-treated with damp hot air.

The residual hydrochloric acid content can be lowered to below 0.025% by this process. Since the silicon dioxide is obtained with a bulk density of only approx. 15 g/l at the end of this process, vacuum compaction follows, with which tamped densities of approx. 50 g/l and more can be established.

The particle sizes of the silicon dioxides can be varied with the aid of the reaction conditions, such as, for example, flame temperature, hydrogen or oxygen content, amount of silicon tetrachloride, residence time in the flame or length of the coagulation zone.

The BET surface area is determined with nitrogen in accordance with DIN 66 131.

The pore volume is determined via the Hg forcing-in method. For this, the sample is dried for 15 h at 100° C. in a drying cabinet and degassed at room temperature in vacuo.

The micropores are determined by plotting an N isotherm and evaluating this by the method of BET, de Boer and Barret, Joyner, Halenda. For this the sample is dried for 15 h at 100° C. in a drying cabinet and degassed for 1 h at 200° C. in vacuo.

The particle size distribution is determined by means of the Cilas Granulameter 715 laser-optical particle size analyzer.

The tamped density is determined in accordance with ASTM D 4164-88.

The content of particles which have tucks is determined by counting on an SEM photograph of suitable magnification. An uncertainty of an estimated +/−10% arises due to particles in which the tuck is covered. Section images can be prepared to detect inner hollow spaces. An opening in the particle, the size of which makes up 5-90% of the particle diameter and which opens wider inwards at least a minimal amount is to be evaluated as a tuck. To rule out a numerical over-representation of very fine particles, only some of the particles of which the diameter is above the D10 value of the particle size distribution weighted according to volume are taken into account.

### Preparation of the Granules According to the Invention in Example 1 to 8

The pyrogenically prepared silicon dioxide is dispersed in completely demineralized water, the particular auxiliary substance being admixed. A dispersing unit which operates by the rotor/stator principle is used here. The suspensions formed are spray dried. The finished product is separated off via a filter or cyclone.

The heat treatment of the spray granules is carried out in muffle ovens.

The spray-dried and optionally heat-treated and/or sifted granules are initially introduced into a mixer for the silanization, and are sprayed optionally first with water and then with the silane Si 108 (trimethoxyoctylsilane) or HMDS (hexamethyldisilazane) with intensive mixing. When the spraying has ended, after-mixing is carried out for a further 15 to 30 min, and then heat treatment for 1 to 4 h at 100 to 400° C.

The water employed can be acidified with an acid, for example hydrochloric acid, down to a pH of 7 to 1. The silanizing agent employed can be dissolved in a solvent, such as, for example, ethanol.

Detailed information on the preparation and the properties of individual granule examples are to be found in table 2. For comparison, granules were prepared in accordance with U.S. Pat. No. 5,776,240.

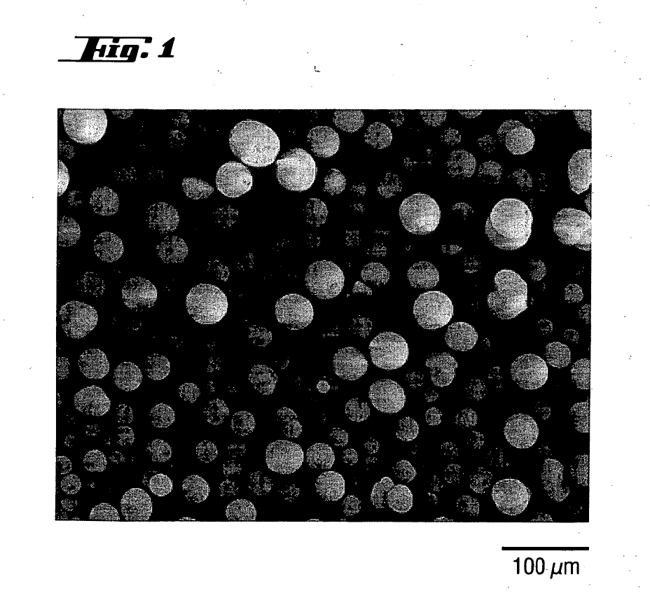

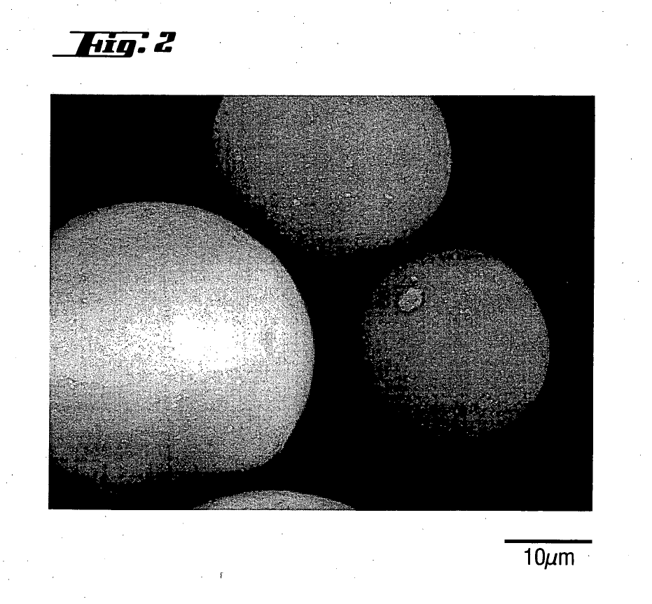

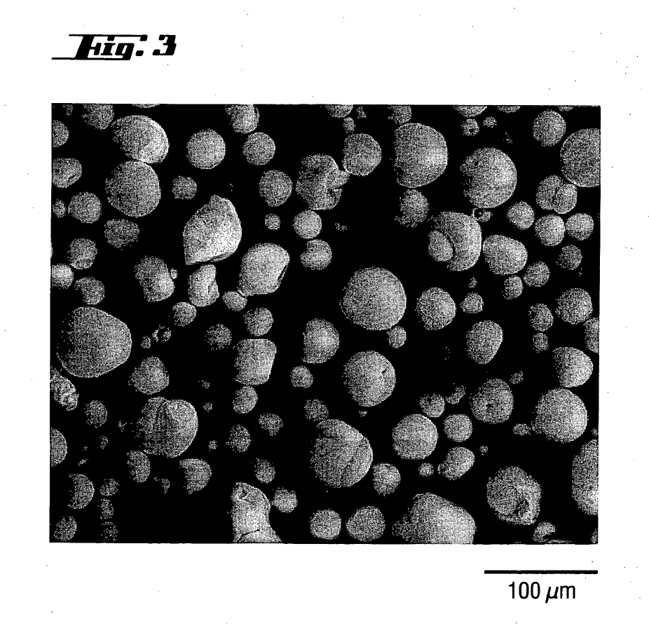

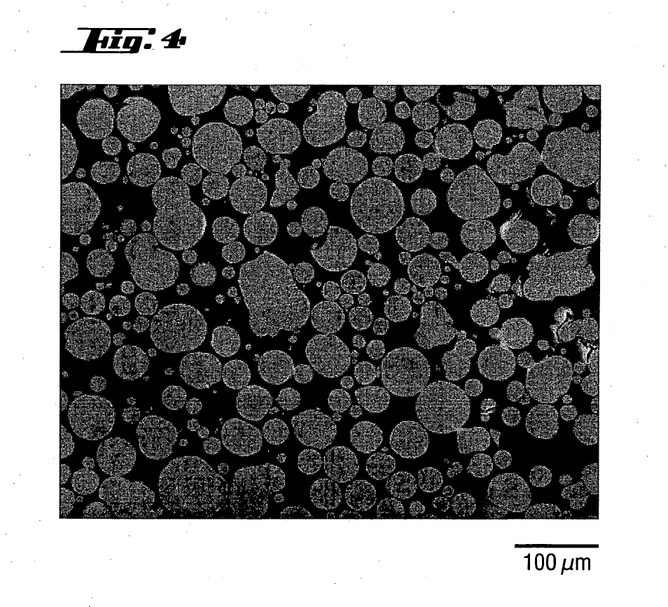

As the SEM photographs of FIG. 1-3 demonstrate impressively, the content of particles with tucks is reduced significantly compared with the prior art. FIG. 4 shows that also no noticeable content of inner hollow spaces is present.

TABLE 2

| Example | | 1 | 2 | 3 | Comp. | 4 | 5 | 6 | 7 | 8 |
|---|---|---|---|---|---|---|---|---|---|---|
| Starting Aerosil | | 300 | 380 | 380 | 380 | 200 | 300 | 380 | 380 | 380 |
| Spray drying | | | | | | | | | | |
| Amount of H₂O | | 9.3 | 9.3 | 9 | 9 | 9.3 | 9 | 9 | 9 | 9.3 |
| (kg) | | | | | | | | | | |
| Amount of Aerosil | | 0.7 | 0.7 | 1 | 1 | 0.7 | 1 | 1 | 1 | 0.7 |
| (kg) | | | | | | | | | | |
| Auxiliary substance | | A | A | B | — | B | C | D | B | A |
| amount added | | 5.6 g | 5.6 g | 1.5 g | — | 5.6 g | 5.0 g | 10 g | 1.5 g | 5.6 g |
| Atomization with | | Disc | Disc | Disc | Disc | Disc | Disc | Disc | Disc | Disc |
| Separation | | Cyclone/filter | Cyclone/filter | Cyclone/filter | Cyclone/filter | Cyclone | Cyclone | Cyclone | Cyclone/filter | Cyclone/filter |
| Heat treatment | | — | — | — | — | 3/970 | — | — | — | 3/480 |
| (h/° C.) | | | | | | | | | | |
| Modification of the | | | | | | | | | | |
| surface | | | | | | | | | | |
| Reagent | | — | — | — | — | — | — | — | Si 108 | Si 108 |
| Amount [g/100 g | | — | — | — | — | — | — | — | 25 | 25 |
| Aerosil] | | | | | | | | | | |
| Amount of water | | — | — | — | — | | | | — | 5 |
| [g/100 g Aerosil] | | | | | | | | | | |
| Heating time (h) | | — | — | — | — | — | — | — | 2 | 2 |
| Temperature (° C.) | | — | — | — | — | — | — | — | 120 | 120 |
| Sifting | | — | WS/Si | WS/Si | WS/Si | WS | — | — | WS/Si | WS/Si |
| Physico-chem. | | | | | | | | | | |
| data | | | | | | | | | | |
| BET surface area | | 263 | 320 | 315 | 321 | 72 | 271 | n.d. | 210 | 194 |
| (m²/g) | | | | | | | | | | |
| Pore volume (ml/g) | | 1.81 | 1.6 | 1.71 | 1.78 | 0.54 | 1.77 | n.d. | 1.69 | 1.55 |
| Content of | | <5% | <5% | <5% | <5% | <5% | <5% | n.d. | <5% | <5% |
| micropores (<5 nm) | | | | | | | | | | |
| in the total | | | | | | | | | | |
| pore volume | | | | | | | | | | |
| Particle | d50 (μm) | 36 | 50 | 50 | 56 | 40 | 33 | 31 | 48 | 48 |
| size | d10 (μm) | 10 | 23 | 18 | 26 | | | | 21 | 20 |
| | d90 (μm) | 66 | 77 | 76 | 85 | | | | 74 | 76 |

| | | | | | | | | | |
|---|---|---|---|---|---|---|---|---|---|
| Tamped density | 325 | 330 | 320 | 312 | 810 | n.d. | n.d. | 370 | 390 |
| (g/l) | | | | | | | | | |
| Content of particles | <5% | <10% | <15% | 80% | <5% | <10% | 25% | <10% | <10% |
| with tucks (in the | | | | | | | | | |
| size range >D10) | | | | | | | | | |

Explanations:
Auxiliary substances:
A: carboxymethylcellulose, alkali-free
B: soda water-glass solution, 38.2%, SiO₂:Na₂O = 3.33
C: methylhydroxypropylcellulose
D: tetraethyl orthosilicate dissolved in ethanol (50 wt. %)
Sifting:
WS: wind sifting
Si: sieving

1. Granules based on pyrogenically prepared silicon dioxide with the following physico-chemical characteristic data:

| | |
|---|---|
| Average particle diameter: | 10 to 120 μm |
| BET surface area: | 40 to 400 m²/g |
| Pore volume: | 0.5 to 2.5 ml/g |
| Pore distribution: | content of pores of pore |
| | diameter <5 nm in the total |
| | pore volume of less than 5%, |
| | remainder meso- and macropores |
| Tamped density: | 220 to 1,000 g/l |

Numerical content of particles in the particle size range above the D10 value of the particle size distribution weighted according to volume which have tucks or closed off inner hollow spaces: <35%

2. A process for the preparation of granules according to claim 1, comprising dispersing pyrogenically prepared silicon dioxide is in a liquid with one or more auxiliary substances and spray drying the dispersion to obtain the granules.

3. The process according to claim 2, wherein the auxiliary substances include one or more components selected from polymers, acids, bases, sols, or silicic acid esters.

4. The process according to claim 2, one or more components from the following substances are used as auxiliary substances: carboxymethylcelluloses, methylcelluloses or celluloses etherified with other alcohols, water-glass or silica sol.

5. The process for the preparation of granules according to claim 2, further comprising subjecting the granules to heat-treated at a temperature of 150 to 1,100° C.

6. The process for the preparation of granules according to claim 2, further comprising silanizing the granules.

7. The process for the preparation of granules according to claim 2, further comprising sifting or sieving the granules to obtain particle size fractions, which may be separated off, and optionally recycling a desired fraction.

8. The process according to claim 3, wherein the polymers are selected from cellulose derivatives, polyethylene glycol, waxes, polyolefins, polyvinyl alcohols or polyacrylates; the acids are selected from formic, acetic, lactic, oxalic, nitric, hydrochloric or citric acid; the bases are selected from ammonia, amines or alkali metal, alkylammonium or alkaline earth metal hydroxides; the sols are selected from silica sols, aluminium oxide sols or sols of other oxides, water-glass; and the silicic acid esters are tetraethyl orthosilicate.
